(19) United States
(12) Patent Application Publication
(10) Pub. No.: US 2011/0000175 A1
(43) Pub. Date: Jan. 6, 2011

(54) VARIABLE SPEED CONTROLLER

(75) Inventors: Clint Lahey, Mount Pleasant, SC (US); Matt Lambert, Summerville, SC (US)

Correspondence Address: Pearne & Gordon LLP, 1801 East 9th Street, Suite 1200, Cleveland, OH, 44114-3108, US

(73) Assignee: Husqvarna Consumer Outdoor Products N.A. Inc., Augusta, GA (US)

(21) Appl. No.: 12/496,095

(22) Filed: Jul. 1, 2009

(51) Int. Cl. A01D 69/00

(52) U.S. Cl. 56/10.8

(57) ABSTRACT

A variable speed control apparatus 240 is provided for controlling a self-propelled speed of a mowing machine 20 including an operational trigger 38 and a variable speed transmission 44. The variable speed control apparatus 240 includes a body 254 and a cable 242 coupled between the operational trigger 38 and the variable speed transmission 44, and a control lever 268 is rotatably coupled to the body 254 for rotational movement between a first position 70 and a second position 72. A cable tensioner 84 is operatively coupled to the control lever 268 and adapted to translate rotational motion of the control lever 268 to the cable coupler 86. Movement of the control lever 268 towards a first portion relatively decreases tension in the cable 242, and movement towards a second tensioner position relatively increases tension in the cable 242. In one example, the operational trigger 38 is coupled to the handle 28 adjacent the grip portion 34 for operating the variable speed transmission 44 between a halt condition and an advancement condition.

### CROSS-REFERENCE TO RELATED APPLICATIONS

Not Applicable

### FIELD OF THE INVENTION

The subject application relates generally to lawn mowers, and more particularly, to lawn mowers that include a variable speed controller for controlling a self-propelled speed of the lawn mower.

### BACKGROUND OF THE INVENTION

Self-propelled machines, such as lawn mowers and the like, are well-known. Self-propelled lawn mowers generally include a transmission interposed between the mower's power unit (e.g., engine or motor) and one or more driving wheels. In particular, a “walk behind” lawn mower can be self-propelled such that the operator walks behind the machine during movement of the mower in a forward direction.

However, grass cutting conditions are not always stable. As a result, it is also well-known to provide a self-propelled lawn mower with a variable speed transmission that controls the driving speed. For example, grass can be grown on rough grounds, on grounds having changing slopes (i.e., hills or valleys), on grounds having a varying density or thickness of grass or other plants, etc. Additionally, the lawn mower may be operated by various individuals having different walking speeds. Thus, the driving speed of the lawn mower may frequently change to achieve a desired appearance of the cut grass and/or due to operator preference. Thus, there is a continuing need for an improved control system for a self-propelled machine.

### BRIEF SUMMARY OF THE INVENTION

The following presents a simplified summary of the invention of the subject application in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect of the subject application, a self-propelled mowing machine includes a chassis, a power unit, a handle coupled to the chassis including a grip portion, a pair of driving wheels rotatably coupled to the chassis, and a variable speed transmission for propelling the mowing machine. The transmission is interposed between the power unit and the pair of driving wheels. An operational trigger is coupled to the handle adjacent the grip portion for operating the variable speed transmission between a halt condition and an advancement condition. A cable is coupled between the operational trigger and the variable speed transmission, whereby a self-propelled speed of the mowing machine is controlled via a relative tension in the cable. A variable speed control apparatus is provided for controlling the relative tension in the cable. The variable speed control apparatus includes a body, wherein an intermediate portion of the cable extends through the body, a control lever pivotally coupled to the body for pivotal movement between a first lever position and a second lever position, and a rotatable driving member operatively coupled to the control lever. A cable tensioner is coupled to the intermediate portion of the cable and operatively coupled to the driving member for movement between a first tensioner position to relatively decrease tension in the cable, and a second tensioner position to relatively increase tension in the cable. Pivotal movement of the control lever causes rotational movement of the driving member which in turn causes movement of the cable tensioner relative to the control lever.

In accordance with another aspect of the subject application, a self-propelled mowing machine includes a chassis, a power unit, a handle coupled to the chassis including a grip portion, a driving wheel rotatably coupled to the chassis, and a variable speed transmission for propelling the mowing machine interposed between the power unit and the driving wheel. An operational trigger is coupled to the handle adjacent the grip portion for operating the variable speed transmission between a halt condition and an advancement condition. A cable is coupled between the operational trigger and the variable speed transmission, whereby a self-propelled speed of the mowing machine is controlled via a relative position of the cable. A variable speed control apparatus is provided for controlling the relative position of the cable. The variable speed control apparatus includes a body, and a control lever rotatably coupled to the body for rotational movement between a first position and a second position. A cable adjuster is operatively coupled to the control lever and adapted to rotate together with the control lever. The cable adjuster includes a cable coupler adapted to engage the intermediate portion of the cable and to be moveable between a first adjuster position and a second adjuster position. Rotational movement of the control lever towards the first position causes movement of the cable coupler towards the first adjuster position to adjust the intermediate portion of the cable to be relatively closer to the transmission, and rotational movement of the control lever towards the second position causes movement of the cable coupler towards the second adjuster position to adjust the intermediate portion of the cable to be relatively farther from the transmission.

In accordance with another aspect of the subject application, a variable speed control apparatus is provided for controlling a self-propelled speed of a mowing machine including an operational trigger and a variable speed transmission. The variable speed control apparatus includes a body and a cable coupled between the operational trigger and the variable speed transmission, wherein an intermediate portion of the cable extends through the body. A control lever is rotatably coupled to the body for rotational movement between a first position and a second position. A cable adjuster is operatively coupled to the control lever and adapted to rotate together with the control lever. The cable adjuster includes a cable coupler adapted to engage the intermediate portion of the cable and to be moveable between a first adjuster position and a second adjuster position. Rotational movement of the control lever towards the first portion causes movement of the cable coupler towards the first adjuster position to relatively decrease tension in the cable, and rotational movement of the control lever towards the second portion causes movement of the cable coupler towards the second adjuster position to relatively increase tension in the cable.

### BRIEF DESCRIPTION OF THE DRAWINGS

The foregoing and other aspects of the subject application will become apparent to those skilled in the art to which the subject application relates upon reading the following description with reference to the accompanying drawings, in which:

FIG. 1 illustrates a perspective view of a lawn mower that includes example aspects of the subject application;

FIG. 2 is similar to FIG. 1, but the chassis, power unit, and driving wheels have been removed for clarity;

FIG. 3 is similar to FIG. 1, but illustrates another example operational trigger;

FIG. 4 illustrates an exploded, perspective view of an example variable speed control apparatus;

FIG. 5A illustrates a side view of the variable speed control apparatus of FIG. 4 in a first position;

FIG. 5B is similar to FIG. 5A, but illustrates a top view;

FIG. 6A illustrates a side view of the variable speed control apparatus of FIG. 4 in an intermediate position;

FIG. 6B is similar to FIG. 6A, but illustrates a top view;

FIG. 7A illustrates a side view of the variable speed control apparatus of FIG. 4 in a second position;

FIG. 7B is similar to FIG. 7A, but illustrates a top view;

FIG. 8 illustrates a front view of an example operational trigger;

FIG. 9 is similar to FIG. 8, but shows one of the triggers in an engaged position;

FIG. 10 illustrates a reverse perspective view of the operational trigger of FIG. 8 with the housing and other components removed for clarity;

FIG. 11 illustrates an example cam for use with the operational trigger of FIG. 8;

FIG. 12A illustrates a front view of the operational trigger of FIG. 8 with both triggers in a disengaged position;

FIG. 12B is similar to FIG. 12A, but shows one of the triggers in an engaged position;

FIG. 12C is similar to FIG. 12A, but shows both of the triggers in an engaged position;

FIG. 13 illustrates a perspective view of a lawn mower that includes the operational trigger of FIG. 8 without a variable speed control apparatus;

FIG. 14A illustrates a schematic, side view of another variable speed control apparatus in a first position;

FIG. 14B is similar to FIG. 14A, but illustrates the variable speed control apparatus in a second position;

FIG. 15A illustrates a schematic, side view of yet another variable speed control apparatus in a first position; and

FIG. 15B is similar to FIG. 15A, but illustrates the variable speed control apparatus in a second position.

### DESCRIPTION OF EXAMPLE EMBODIMENTS

Example embodiments that incorporate one or more aspects of the present invention of the subject application are described and illustrated in the drawings. These illustrated examples are not intended to be a limitation on the subject application. For example, one or more aspects of the subject application can be utilized in other embodiments and even other types of devices. Moreover, certain terminology is used herein for convenience only and is not to be taken as a limitation on the subject application. Still further, in the drawings, the same reference numerals are employed for designating the same elements.

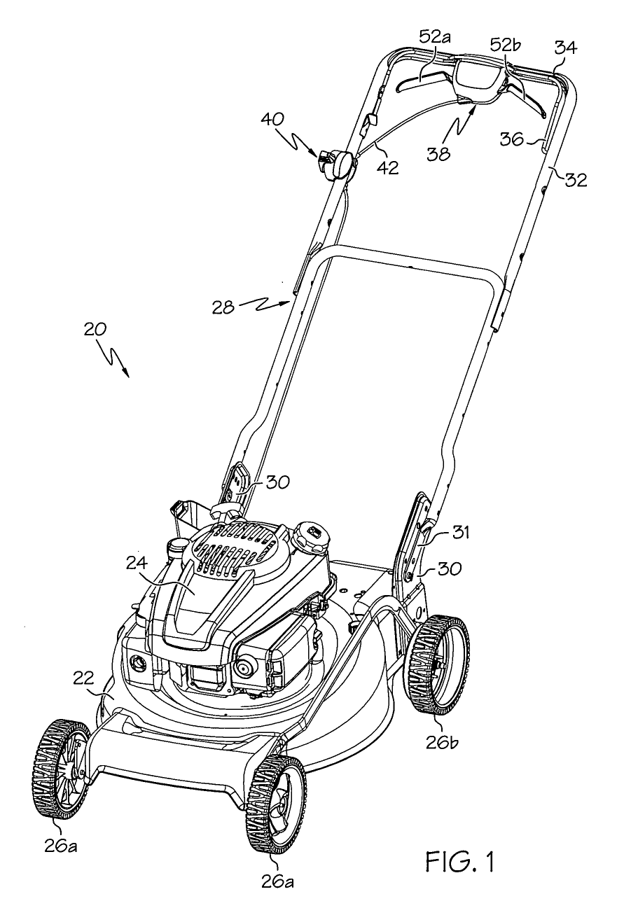

Turning to the shown example of FIG. 1, an example self-propelled, walk behind lawn mower 20 is shown in accordance with example aspects of the subject application. The lawn mower 20 includes a chassis 22, such as a cutting deck, onto which a power unit 24 is mounted. As can be appreciated, the power unit 24 powers one or more blades (not shown) that are located within the chassis for cutting grass and/or other vegetation. The power unit 24 may be of various configurations such as electric, gasoline powered, and/or other. Also, the one or more blades may have various configurations. Still further, the chassis 22 may have various configurations and features. However, the chassis 22 is generally supported by a plurality of ground engaging wheels 26a, 26b. These wheels may be fairly movable or may be powered via a direct or indirect drive connection to the power unit 24. For example, as shown, the front pair of wheels 26a are non-powered, while either or both of the rear pair of wheels 26b can be powered (i.e., driving wheels).

In general, the chassis 22, power unit 24, and/or cutting blades may have various additional structures and features that are not shown herein. For example, the chassis 22 can include various discharge openings for cut grass. In the shown example, the chassis 22 can include a rearwardly directed discharge for cut grass. The orientation of rearwardly is with respect to the normal election that the walk behind mower 20 moves during the cutting operation. It should be appreciated that the discharge may have a variety of configurations, shapes, placements etc. on the rear side (or even at other locations) of the chassis 22.

Also located at the rear side of the chassis 22 is at least one handle 28 that is coupled to the chassis 22. In the shown example, there are two supports 30 being located respectively on the left and right sides of the chassis 22 that may have any of various constructions and configurations. In the shown example, each support 30 is a generally plate-like structure which may have one or more reinforcement segments provided via bending or contouring of the material. In general, the material is typically metal. However, different materials such as plastic composite may be utilized. A plurality of mounting holes, apertures, studs or the like are located on each support 30. These holes and studs on one portion provide a means to connect the handle 28 to the chassis 22. In the shown example, an end 31 of the handle 28 is pivotally and adjustably coupled to the supports 30.

Generally, the handle 28 extends generally upwardly and rearwardly away from the chassis 22. The operator handle 28 may have any of several configurations and constructions. In general, the operator handle 28 extends upwardly in a general U-shape. The U-shape may be bifurcated to permit folding of the handle for storage. An upper portion 32 of the handle 28 is located at a generally ergonomic location and can include a grip portion 34 to be held or gripped by an operator who is located in an operator location directly behind the walk behind mower 20. The grip portion 34 can include various surface treatments and/or additional grip members, such as a plastic or rubber grip overlay or the like. One or more operation components may be mounted upon the handle 28 for operation of the mower 20 by the operator. For example, the operation components can include any or all of a throttle, a choke, an operational trigger 38 (as will be discussed more fully herein), a variable speed control 40 (as will be discussed more fully herein), and the like.

In addition or alternatively, an operator presence bail 36 or a blade brake clutch control can also be located on the handle 28 adjacent to an upper portion thereof (e.g., adjacent the grip portion 34). The operator presence structure can be pivotally mounted to the upper portion of the handle 28 such that the operator moves the bail 36 or control to an operation position when the operator is at the operator location and intends to operate the walk behind mower for cutting grass. In the shown example, the operator presence bail 36 is a movably mounted U-shaped member that is connected to the handle 28 via a movable mount, and can be resiliently biased towards a disengaged position. Specifically, the movable mount is a pivot mount such that the bail 36 can pivot back and be located against the upper portion of the handle 28, though the bail 36 or blade brake clutch can also have various other constructions and/or mounts. It is to be noted that FIG. 1 shows the operator presence bail 36 in the engaged position (i.e., located against/adjacent to the grip portion 34 of the handle 28). The operator presence bail 36 can be connected, via a cable or the like (not shown), to one or more components of the mower 20 that concern operation of the mower. As a safety feature, if the operator releases the bail 36, the power unit 24 and/or the mower blade can be configured to stop. For example, a blade brake, and/or clutch mechanism may be provided such that the blade is only operated when the operator presence bail is actuated and in the engaged position as shown in FIG. 1. However, it is to be understood that the structure may be different from the shown example.

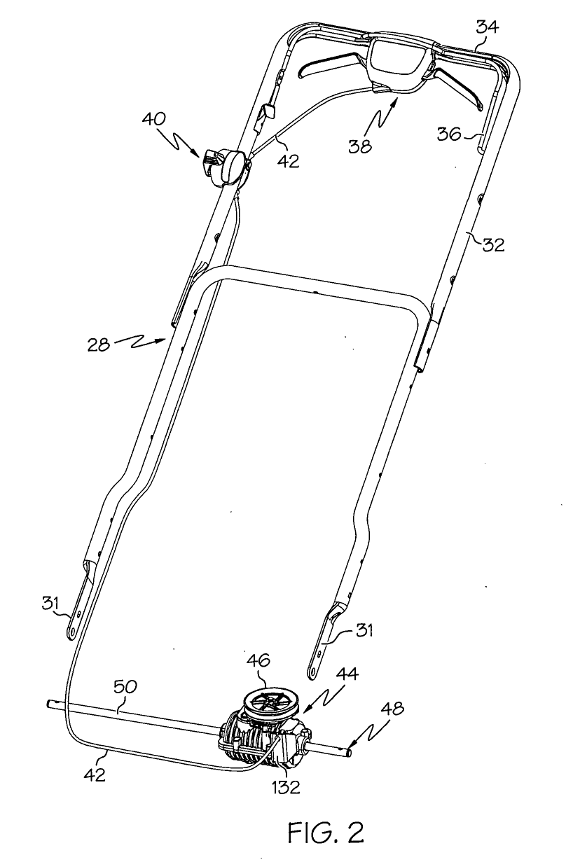

Turning now to FIG. 2, the self-propelled lawn mower 20 generally includes a transmission 44 interposed between the power unit 24 and one or more driving wheels 26b for propelling the mower 20. It is to be understood that various components of the lawn mower 20 have been removed for clarity. For example, the chassis 22, power unit 24, and driving wheels 26a, 26b are not illustrated.

The transmission 44 can be a single speed transmission, such as a non-adjustable transmission. Alternatively, as shown, can be a variable speed transmission 44. The variable speed transmission 44 can include various types of transmissions, such as a geared transmission, a belt-operated transmission, a hydraulically-operated transmission, etc. Moreover, the variable speed transmission 44 can have a plurality of discrete speeds (i.e., a plurality of fixed gear ratios), and/or can be continuously variable within a range of speeds (i.e., steplessly or continuously vary the gear ratio). The power unit 24 can supply operational power to the transmission 44 in various direct or indirect manners. For example, as shown, power can be supplied via a belt-driven pulley system having a driven pulley 46 coupled to the transmission 44, though power can also be supplied via a direct drive, gears, etc. Thus, the power unit 24 can supply operational power to the driving wheels 26b through the transmission 44 in various manners, thereby rendering the mower 20 to be self-propelled. The transmission 44 can output the operational power as torque to the driven wheels 26b via an output shaft 48 or the like, which can be directly or indirectly coupled to the driven wheels 26b, such as by an additional gear transfer case or the like. In addition or alternatively, the transmission can also be operatively coupled to both wheels 26b via a through shaft 50, or even an auxiliary shaft, so as to drive both wheels 26b simultaneously. Still, a differential or the like (not shown) can also be utilized to permit the wheels 26b to operate at different rotational rates.

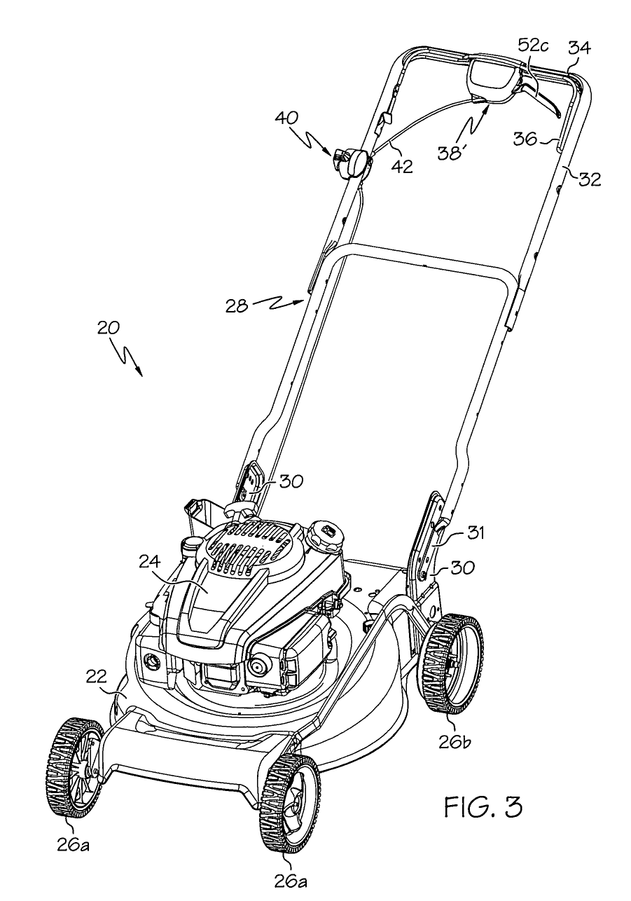

The transmission 44 can be selectively operated between a halt condition and an advancement condition via the operational trigger 38. For example, as shown, the operational trigger 38 can be coupled to the handle 28 generally adjacent the grip portion 34 and include one or more triggers 52a, 52b for selective operation by the hands of the operator. In such a placement, the operator can operate both of the operator presence bail 36 and the triggers 52a, 52b of the operational trigger 38 simultaneously. The operational trigger 38 can be operatively coupled to the transmission 44 by a cable 42, as shown, though can also be coupled via a solid link or the like. In one example, the cable 42 can be a cable movable within a flexible conduit, such as a steel-lined conduit, though various other cables can also be utilized. Thus, as will be discussed more fully herein, an operator can selectively operate the transmission 44 to place the mower 20 in an advancement condition by moving either or both of the triggers 52a, 52b to an engaged position, and alternatively, can place the mower 20 in a halt condition by releasing both of the triggers 52a, 52b to a disengaged position. Though the operational trigger 38 is illustrated in FIGS. 1-2 as having a pair of triggers 52a, 52b, it is to be understood that the operational trigger 38′ can include only a single trigger 52c, as shown in FIG. 3, to control operation of the transmission.

The speed of the transmission 44, that is, the speed at which the mower 20 traverses the ground, can be adjusted variously. In the shown example, the output speed of the continuously variable transmission 44 can be controlled via the variable speed control apparatus 40. Specifically, where a cable 42 is used, the speed of the transmission 44 (and therefore the self-propelled speed of the mower 20) can be controlled via the relative position of the cable 42 and/or the relative tension in the cable. Thus, by varying the relative position and/or tension of the cable, an operator can selectively adjust the variable speed control apparatus 40 to adjust the output speed of the continuously variable transmission 44, and thus the driving speed of the wheels 26b. The variable speed control apparatus 40 can provide control of the transmission 44 over a continuous or substantially continuous range between a zero or low speed and a maximum or high speed.

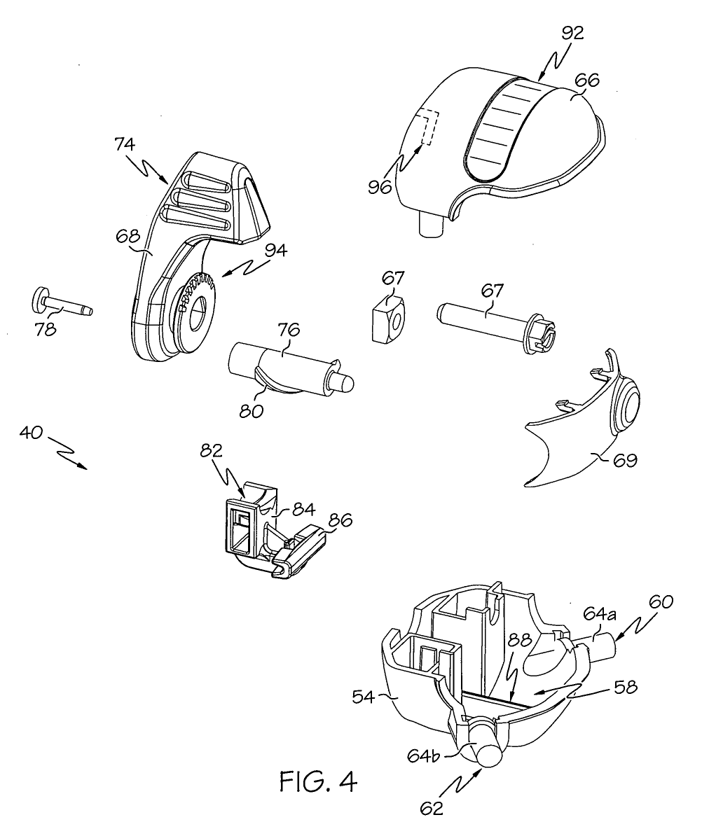

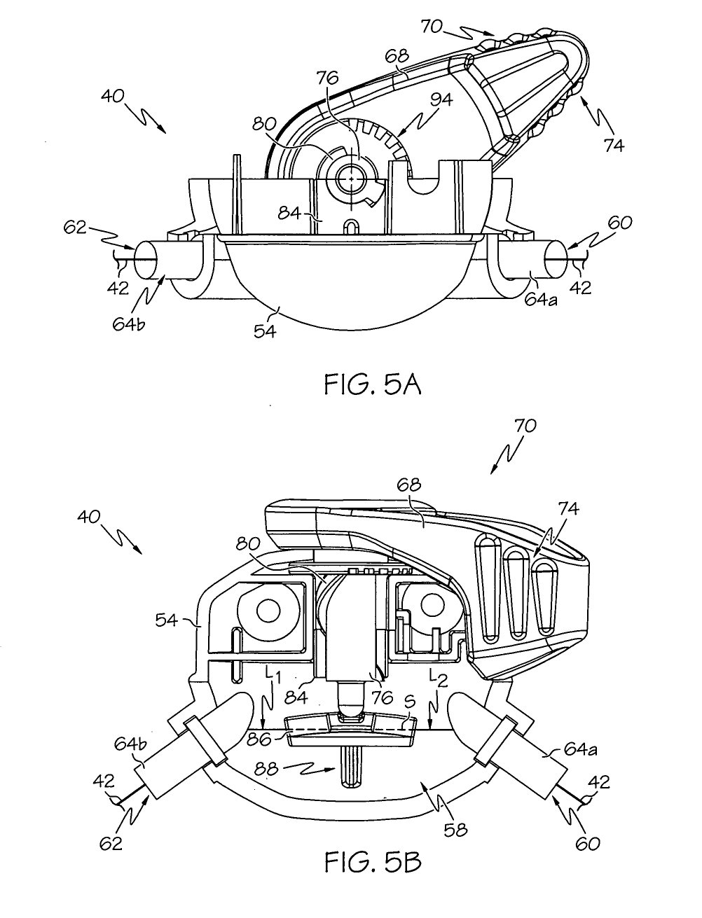

Turning now to FIG. 4, an example variable speed control apparatus 40 for controlling the relative position and/or tension of the cable 42 will be described. The variable speed control apparatus 40 can include a body 54 having an interior chamber 58. An intermediate portion 56 of the cable 42 (i.e., a portion located between the operational trigger 38 and the transmission 44, see FIGS. 5A-7B) can extend through the interior chamber 58 of the body 54. The body 54 can include first and second openings 60, 62 to permit the intermediate portion 56 of the cable 42 to enter and exit the body 54. In addition or alternatively, such as where the cable 42 is a cable movable within a flexible conduit, the first and second openings 60, 62 can include structure (such as keyed structure) for receiving and securing corresponding outer cable attachment structure 64a, 64b. In addition or alternatively, the body 54 can include a grommet, bushing, or the like (not shown) at the first and second openings 60, 62 to facilitate passage of the cable 42 therethrough. A cover 66 and/or side closure 69 can be coupled to the body 54 to enclose and at least partially define the interior chamber 58. Further, the elements of the variable speed control apparatus 40 can be removably or non-removably coupled together by adhesives, welding, and/or by various mechanical fasteners 67, such as screws, nuts, bolts, etc.

The variable speed control apparatus 40 can further include a control lever 68 pivotally coupled to the body 54 for pivotal movement between a first lever position 70 and a second lever position 72 (see FIGS. 5A-7B). The control lever 68 can be pivotally coupled to the body 54 in various manners, and may even be pivotally coupled to the cover 66. The control lever 68 can generally include a grip 74 disposed towards one end for use by an operator.

Further, a cable adjuster can be operatively coupled to the control lever 68 and can be adapted to translate rotational motion of the control lever 68 into generally linear motion. The cable adjuster can also be operatively coupled to the intermediate portion 56 of the cable 42 to selectively adjust the position and/or tension of the cable 42 for adjusting a self-propelled speed of the mower 20. In one example, the cable adjuster can include a rotatable driving member 76 that is operatively coupled to the control lever 68 in various manners. For example, the rotatable driving member 76 can be coupled to the control lever 68 via mechanical fasteners 78 or the like (e.g., screws, bolts, pins, etc.). In other examples (not shown) of mechanical fasteners, the rotatable driving member 76 can include snaps, clips, clasps, etc. that are coupled to the control lever 68, and/or the rotatable driving member 76 can even be formed with the control lever 68. Thus, the rotatable driving member 76 is rotatable relative to the body 54 upon pivotal movement of the control lever 68. In the shown example, the rotatable driving member 76 is generally rotatable in a 1:1 ratio relationship with the control lever 68, though it is to be understood that a gearing mechanism or the like (not shown) could also be utilized to vary the rotation ratio therebetween.

The rotatable driving member 76 can further include male screw structure 80 about an outer periphery thereof. As a result, pivoting motion of the control lever 68 causes rotation of the male screw structure 80 about the rotational axis of the rotatable driving member 76. The male screw structure 80 is generally engaged with corresponding female screw structure 82 of a cable tensioner 84 that is operatively coupled to the intermediate portion 56 of the cable 42. The cable tensioner 84 can include various structure for engagement with the intermediate portion 56 of the cable 42. In one example, the cable tensioner 84 can include a cable coupler 86 having a generally “C”-shaped geometry or a generally “U”-shaped geometry, though various other geometries are also contemplated. The generally “C”-shaped geometry and a generally “U”-shaped geometry of the cable coupler 86 can at least partially “wrap around” the intermediate portion 56 of the cable 42 (i.e., see FIGS. 5A-7B) to permit the cable tensioner 84 to selectively adjust the position and/or tension of the cable 42 via movement of the cable tensioner 84 relative to the body 54.

The cable tensioner 84 is adapted to move relative to the body 54, and is driven by the rotation of the rotatable driving member 76. The cable tensioner 84 can move in various manners. In one example, the cable tensioner 84 can be adapted to move along a generally linear path, such as a straight-line path, a curved path, a zig-zag path, a random path, or the like. Moreover, the path of travel of the cable tensioner 84 can be oriented variously relative to a longitudinal axis of the cable, such as a longitudinal axis of the intermediate portion 56 of the cable 42. In one example, as shown in FIGS. 5B, 6B, and 7B, the cable tensioner 84 can be adapted for linear movement along an axis oriented generally transverse (i.e., perpendicular) to a longitudinal axis of the cable 42. In addition or alternatively, the cable tensioner 84 can be guided via a guide path 88 coupled to or formed with the body 54. For example, the guide path 88 can include a projecting member and/or a recessed portion or the like.

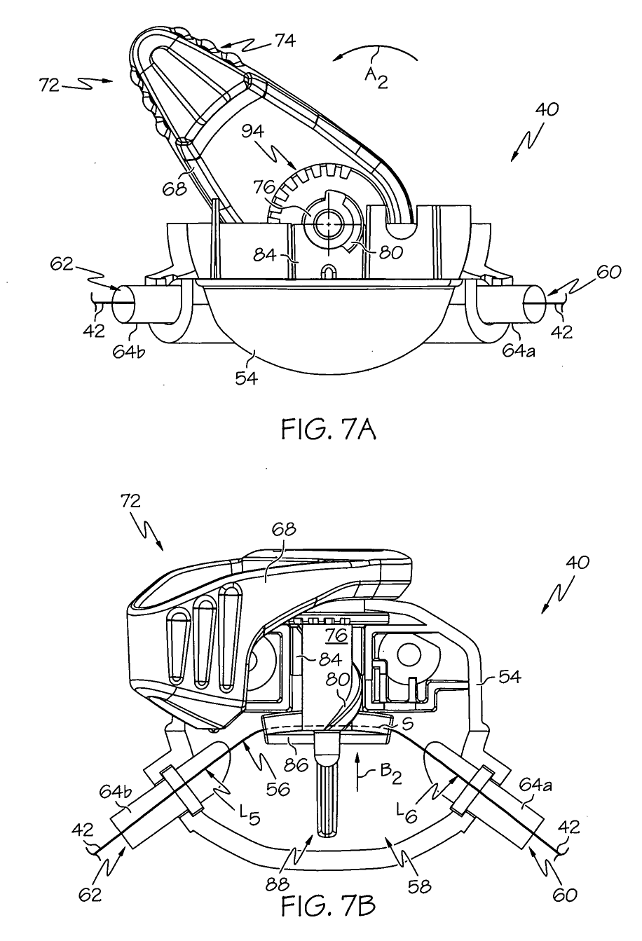

Thus, pivoting motion of the control lever 68 causes rotational movement of the male screw structure 80 about the rotational axis of the rotatable driving member 76. Engagement of the rotating male screw structure 80 with the corresponding female screw structure 82 of the cable tensioner 84 drives the generally linear movement of the cable tensioner 84 relative to the control lever 68 and/or body 54. As a result, the cable tensioner 84 is generally movable between a first position (see FIGS. 5A-5B) to relatively decrease tension in the cable 42 (i.e., to adjust the intermediate portion 56 of the cable 42 to be relatively closer to the transmission 44), and a second position (see FIGS. 7A-7B) to relatively increase tension in the cable 42 (i.e., to adjust the intermediate portion 56 of the cable 42 to be relatively farther from the transmission 44).

Turning now to FIGS. 5A-7B, example operations of the cable adjuster will now be discussed. As shown in FIGS. 5A-5B, the control lever 68 is illustrated generally in the first lever position 70, while the cable tensioner 84 is similarly illustrated generally in the first position. The length of the cable 42 located within the interior chamber 58 of the body 54 is generally equal to the sum of lengths L₁, L₂, and S, wherein S denotes the length of cable 42 engaged by the cable coupler 86. The lengths L₁ and L₂ (and also L₃-L₆) can be measured variously, though for the purposes of this discussion, are intended to be bounded between the inner edge of the corresponding cable attachment structure 64a, 64b and the cable coupler 86. However, because the length S remains generally constant (or may change by a de minimis amount) with movement of the cable tensioner 84 between the first and second positions, the length S will cancel out in cable length comparisons and be generally ignored for purposes of this discussion. Thus, the length of the cable 42 located within the interior chamber 58 at the first position of FIGS. 5A-5B is generally equal to (L₁+L₂).

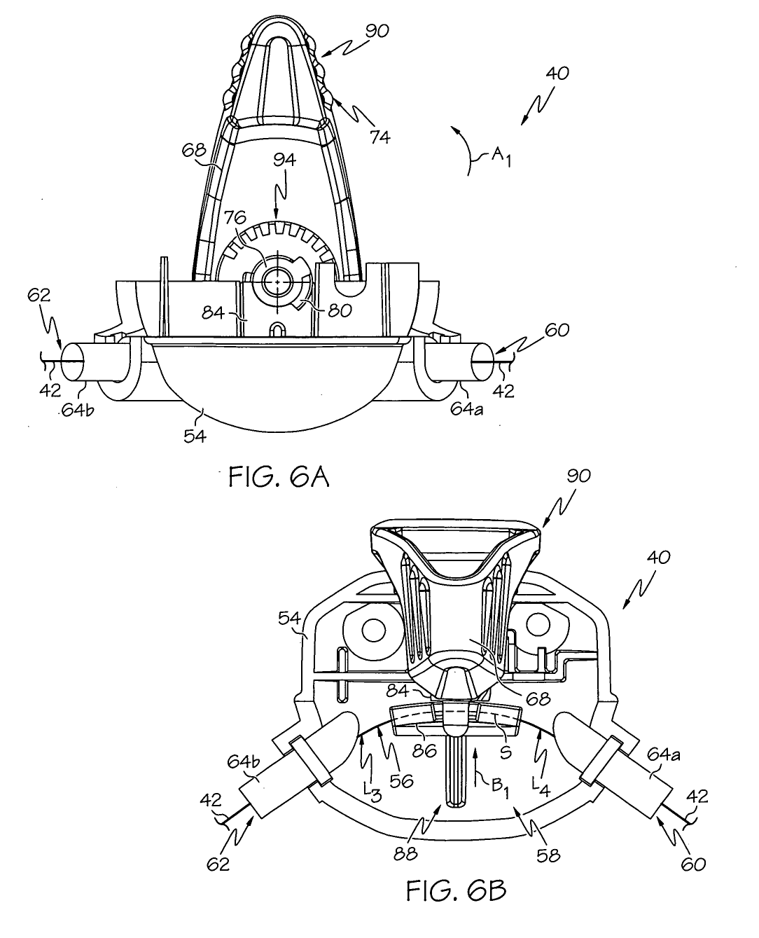

Turning now to FIGS. 6A-6B, the control lever 68 is rotated a distance along the direction of arrow A₁ to an intermediate lever position 90 between the first and second positions 70, 72. Rotation of the control lever 68 causes rotation of the rotatable driving member 76, which in turn causes linear movement of the cable tensioner 84 along the direction of arrow B₁. As a result, a tension in the cable 42 is increased relative to that of the first lever position 70. Specifically, additional cable 42 is drawn into the interior chamber 58 via either or both of the first and second openings 60, 62, such that the length of cable 42 located within the interior chamber 58 at the intermediate position 90 is equal to (L₃+L₄). Thus, the increase in cable length within the interior chamber 58 is generally equal to (L₃+L₄)−(L₁+L₂). Because the ends of the cable 42 are either fixed or spring-coupled to the operational trigger 38 and/or the transmission 44, and the remainder of the cable 42 is not generally loose, the increase in cable length can cause the relative increase in tension in the cable 42. In another example, where one end of the cable 42 is generally fixed to the operational trigger 38 and resiliently-coupled (e.g., spring-coupled) to the transmission 44, the increase in cable length can be provided by adjusting the relative position of the intermediate portion 56 relative to the transmission 44. Specifically, as the control lever 68 is moved towards the intermediate position 90, the intermediate portion 56 of the cable 42 can be moved relatively farther from the transmission 44.

Turning now to FIGS. 7A-7B, the control lever 68 is further rotated a distance along the direction of arrow A₂ to the second position 72. Rotation of the control lever 68 causes continued rotation of the rotatable driving member 76 to cause continued linear movement of the cable tensioner 84 along the direction of arrow B₂. As a result, a tension in the cable 42 is further increased relative to that of the intermediate lever position 90. Specifically, additional cable 42 is drawn into the interior chamber 58 via either or both of the first and second openings 60, 62, such that the length of cable 42 located within the interior chamber 58 at the second position 72 is equal to (L₅+L₆). Thus, the increase in cable length within the interior chamber 58, relative to the first position 70, is generally equal to (L₅+L₆)−(L₁+L₂). Thus, the increase in cable length can cause the relative increase in tension in the cable 42, and the intermediate portion 56 can be moved relatively farther from the transmission 44.

It is to be understood that the intermediate lever location 90 discussed herein is merely one example lever location between the first and second lever locations 70, 72. Indeed, the cable tensioner 84 can be adapted to provide infinite adjustability of the tension and/or relative positioning of the cable 42 within a range defined between the first tensioner position (FIGS. 5A-5B) and the second tensioner position (FIGS. 7A-7B). The range can also be otherwise defined, such as by the first and second lever positions 70, 72, by the length and/or geometry of the male or female screw structure 80, 82, and/or even by a mechanical stop provided to the various components of the variable speed control 40 discussed herein. Moreover, the structure described herein can also be configured to provide discrete adjustability of the cable tension and/or position among a plurality of predetermined values.

It is to be appreciated that the “screw-drive” example (i.e., male and female screw structure 80, 82) discussed herein is only intended to provide one example operation of the cable adjuster. Indeed, the cable adjuster can have various other configurations that are adapted to translate rotational motion of the control lever 68 into generally linear motion of the cable tensioner 84. For example, the cable adjuster can include various configurations, such as worm gears, rack and pinion gears, lead-screw assemblies, ball-screw assemblies, or the like.

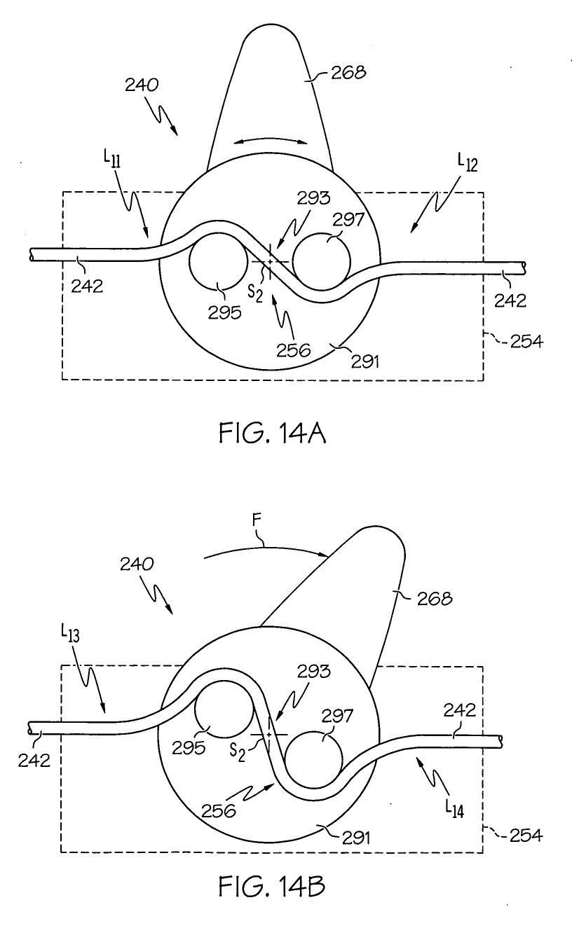

Turning now to FIGS. 14A-14B, another example variable speed control apparatus 240 is illustrated. As before, the variable speed control apparatus 240 can include a control lever 268 pivotally coupled to a control body 254 for pivotal movement between a first lever position (FIG. 14A) and a second lever position FIG. 14B. The control body 254 and associated structure can be similar to that shown in FIGS. 4 and 5A, though can also be different and include more or less elements. A cable adjuster can be operatively coupled to the control lever 268 and can be adapted to rotate together with the control lever 268 in a 1:1 ratio relationship, or other ratio relationship.

The cable adjuster can also include a cable coupler operatively coupled to the intermediate portion 256 of the cable 242 to selectively adjust the position and/or tension of the cable 242 for adjusting a self-propelled speed of the mower 20. For example, the cable adjuster 291 can include a rotatable driving member pivotable about an axis 293. The cable adjuster 291 can be directly or indirectly coupled to the control lever 268 so as to rotate together therewith (i.e., the axis 293 can also be the rotational axis of the lever 268). The rotatable driving member of the cable adjuster 291 can include a plurality of protrusions 295, 297 extending a distance therefrom. The intermediate portion 256 of the cable 242 can extend between the protrusions 295, 297 in a serpentine fashion. At least a portion of either or both of the protrusions 295, 297 can also include a generally “C”-shaped or “U”-shaped geometry (not shown) about a periphery thereof to facilitate coupling to the intermediate portion 256 of the cable 242.

In FIG. 14A, the control lever 268 is illustrated generally in the first lever position, and the cable adjuster 291 (which can be a cable tensioner) is similarly illustrated generally in the first position. The length of the cable 242 located within the interior chamber of the body 254 is generally equal to the sum of lengths L₁₁, L₁₂, and S₂, wherein S₂ denotes the length of cable 242 engaged by the protrusions 295, 297. As before, because the length S₂ remains generally constant (or may change by a de minimis amount) with movement of the cable adjuster 291 between the first and second positions, the length S₂ will cancel out in cable length comparisons and be generally ignored for purposes of this discussion. Thus, the length of the cable 242 located within the interior chamber at the first position of FIG. 14A is generally equal to (L₁₁+L₁₂).

In FIG. 14B, the control lever 268 is rotated along the direction of arrow F to the second position. Rotation of the control lever 268 causes corresponding rotation of the cable adjuster 291 along the direction of arrow F, which similarly causes rotation of the protrusions 295, 297 about the axis 293. As a result, a tension in the cable 242 is increased relative to that of the first position. Specifically, the cable 242 wraps about an outer periphery of the protrusions 295, 297, drawing additional cable 242 into the interior chamber via either or both of the first and second openings such that the length of cable 242 located within the interior chamber at the second position is equal to (L₁₃+L₁₄). Thus, the increase in cable length within the interior chamber, relative to the first position, is generally equal to (L₁₃+L₁₄)−(L₁₁+L₁₂). Thus, the increase in cable length can cause the relative increase in tension in the cable 242, and the intermediate portion 256 can be moved relatively farther from the transmission 44 for controlling a self-propelled speed of the mowing machine.

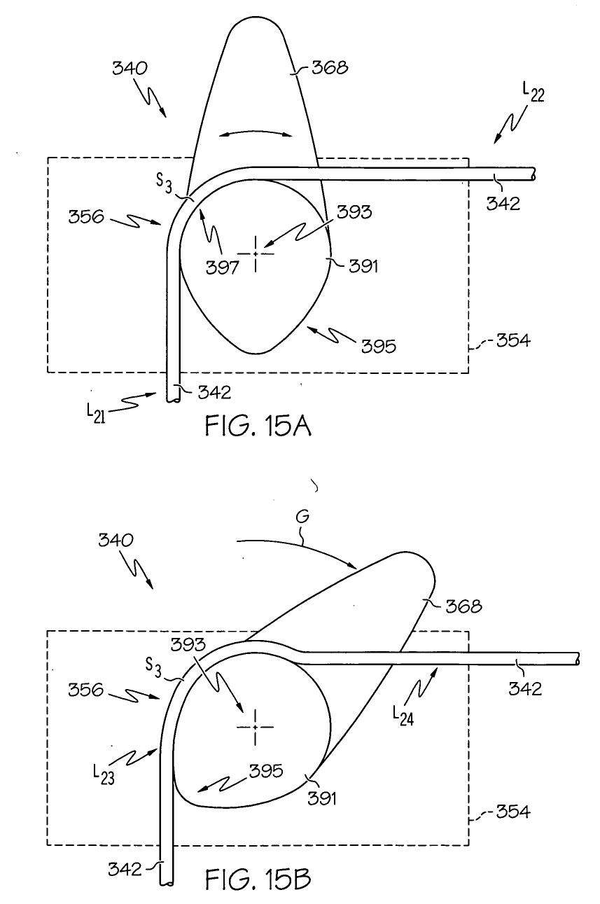

Turning now to FIGS. 15A-15B, yet another example variable speed control apparatus 340 is illustrated. As before, the variable speed control apparatus 340 can include a control lever 368 pivotally coupled to a control body 354 for pivotal movement between a first lever position (FIG. 15A) and a second lever position FIG. 15B. The control body 354 and associated structure can be similar to that shown in FIGS. 4 and 5A, though can also be different and include more or less elements. A cable adjuster can be operatively coupled to the control lever 368 and can be adapted to rotate together with the control lever 368 in a 1:1 ratio relationship, or other ratio relationship.

The cable adjuster can also include a cable coupler operatively coupled to the intermediate portion 356 of the cable 342 to selectively adjust the position and/or tension of the cable 342 for adjusting a self-propelled speed of the mower 20. For example, the cable adjuster 391 can include a rotatable driving member which is a rotatable cam pivotable about an axis 393. The cable adjuster 391 can be directly or indirectly coupled to the control lever 368 so as to rotate together therewith (i.e., the axis 393 can also be the rotational axis of the lever 368). The cable adjuster 391 can include a generally circular portion 397 at one end thereof, and an extended cam portion 395 at the other end thereof. The extended cam portion 395 can have a radius, with respect to the axis 393, relatively greater than the generally circular portion 397. The intermediate portion 356 of the cable 342 can wrap about the generally circular portion 397 of the cable adjuster 391. At least a portion of the outer periphery of the cable adjuster 391 can also include a generally “C”-shaped or “U”-shaped geometry (not shown) about a periphery thereof to facilitate coupling to the intermediate portion 356 of the cable 342.

In FIG. 15A, the control lever 368 is illustrated generally in the first lever position, and the cable adjuster 391 (which can be a cable tensioner) is similarly illustrated generally in the first position. The length of the cable 342 located within the interior chamber of the body 354 is generally equal to the sum of lengths L₂₁, L₂₂, and S₃, wherein S₃ denotes the length of cable wrapped about the generally circular portion 397. As before, because the length S₃ remains generally constant (or may change by a de minimis amount) with movement of the cable adjuster 391 between the first and second positions, the length S₃ will cancel out in cable length comparisons and be generally ignored for purposes of this discussion. Thus, the length of the cable 342 located within the interior chamber at the first position of FIG. 15A is generally equal to (L₂₁+L₂₂).

In FIG. 15B, the control lever 368 is rotated along the direction of arrow G to the second position. Rotation of the control lever 368 causes corresponding rotation of the cable adjuster 391 along the direction of arrow G, which similarly causes rotation of the extended cam portion 395 about the axis 393. As a result, a tension in the cable 342 is increased relative to that of the first position. Specifically, the cable 342 wraps about an outer periphery of the extended cam portion 395 (i.e., which has a relatively greater perimeter via the greater radius), drawing additional cable 242 into the interior chamber via either or both of the first and second openings such that the length of cable 342 located within the interior chamber at the second position is equal to (L₂₃+L₂₄). Thus, the increase in cable length within the interior chamber, relative to the first position, is generally equal to (L₂₃+L₂₄)−(L₂₁+L₂₂). Thus, the increase in cable length can cause the relative increase in tension in the cable 242, and the intermediate portion 356 can be moved relatively farther from the transmission 44 for controlling a self-propelled speed of the mowing machine.

In addition or alternatively, the variable speed control 40 can also include various other features. In one example, the cover 66 can include indicia 92 for indicating a self-propelled speed of the mower 20 based upon a position of the control lever 68 relative to the cover. The indicia 92 can include letters, numbers, and/or symbols, and can indicate a relative or an absolute speed of the mower 20.

In another example, the control lever 68 can include a sensory feedback element 94 for operative engagement with corresponding structure of the body 54 or the cover 66 to provide sensory feedback to an operator upon pivotal movement of the control lever 68 relative to the body 54. For example, the sensory feedback element 94 can include a plurality of recesses arranged in a pattern, such as an array. The plurality of recesses can be adapted to engage a resilient, flexible element 96 of the body 54 or cover 66, such as a cantilevered element or a spring-loaded element, to provide “clicking” sensory feedback that can be audible and/or tactile. The sensory feedback can facilitate speed selection by the operator. In addition or alternatively, the sensory feedback can also be adapted to provide the discrete adjustability of the cable tension and/or position among a plurality of predetermined values.

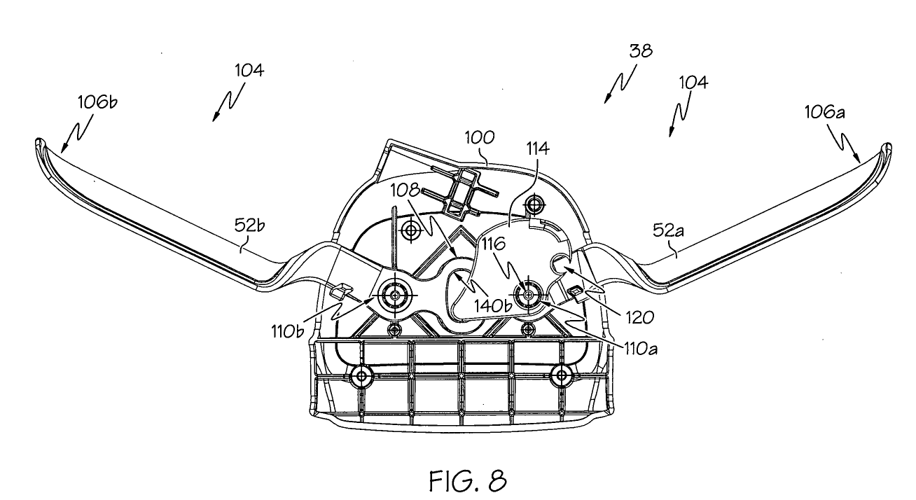

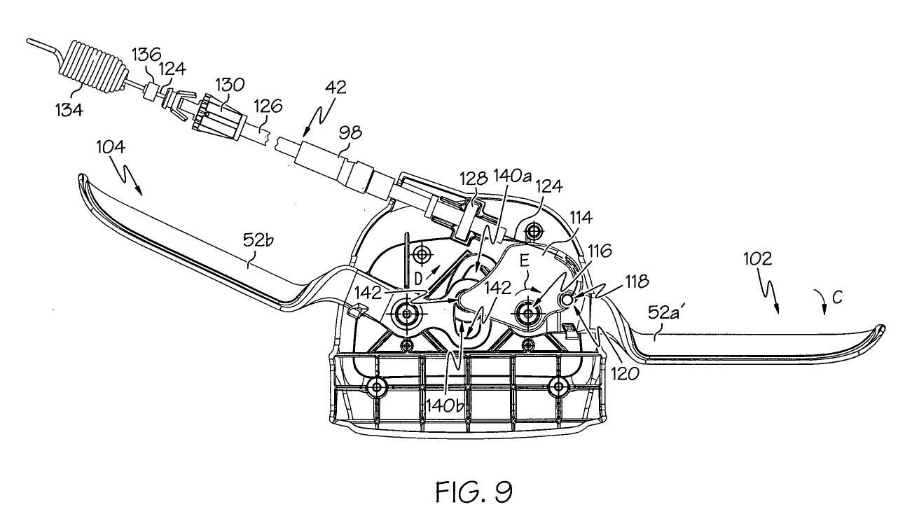

In still yet another example, where the cable 42 is a cable movable within a flexible conduit, an auxiliary tension adjuster 98 can be provided to the cable 42. Generally, a cable movable within a flexible conduit includes a movable, flexible cable contained within a fixed outer casing. Thus, as shown in FIG. 9, the auxiliary tension adjuster 98 of the cable movable within a flexible conduit can be used to selectively increase or decrease the length of the fixed outer casing, thereby increasing or decreasing tension in the flexible cable contained therein. The auxiliary tension adjuster 98 can be utilized as a fine tension adjuster to provide further adjustment of the mower speed, and/or can be utilized to compensate for changes in cable tension over time. For example, the cable tension may decrease over time due to cyclic tension changes during use.

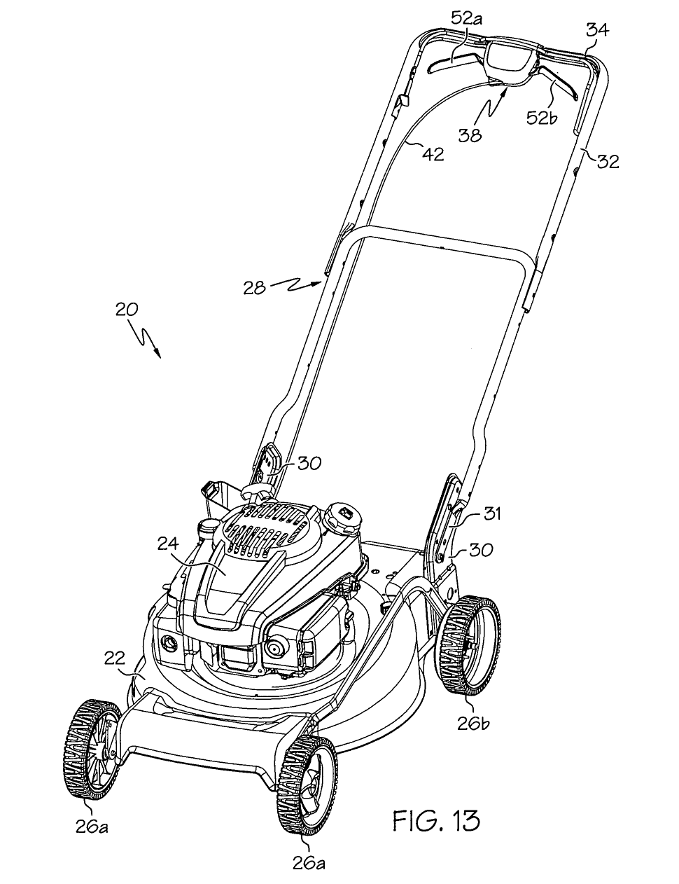

Turning now to FIG. 8, the transmission 44 can be selectively operated between a halt condition and an advancement condition via the operational trigger 38. It is to be understood that the operational trigger 38 can be utilized with or without the variable speed control 40 discussed previously herein. For example, as shown in FIG. 13, where the transmission 44 is a single speed transmission, such as a non-adjustable transmission, the operational trigger 38 can selectively operate the transmission between the halt condition and the advancement condition at the single speed. Alternatively, when a variable speed control 40 is utilized, the operational trigger 38 can selectively operate the transmission 44 between the halt condition and the advancement condition at the speed selected via usage of the variable speed control 40. Still, it is to be appreciated that the operational trigger 38 can also be utilized with a variable speed transmission that is selectively controlled by an apparatus other than the variable speed control 40 discussed herein.

The operational trigger 38, which can also be referred to as a trigger control system, is coupled to the handle 28 of the mower 20 (i.e., see FIG. 1), and can be located generally adjacent the grip portion 34 to facilitate use by an operator. The trigger control system 38 generally includes a housing 100 for containing the various components. It is to be understood that the housing 100 is illustrated in FIGS. 8-9 with a top cover removed for clarity. The trigger control system 38 can further include a plurality of independently operable triggers 52a, 52b rotatably coupled to the housing 100 for movement between an engaged position 102 and a disengaged position 104. As shown in FIG. 8, both triggers 52a, 52b are illustrated in the disengaged position 104, while in FIG. 9, one of the triggers 52a′ is illustrated in the engaged position 102 rotated generally along the direction of arrow C.

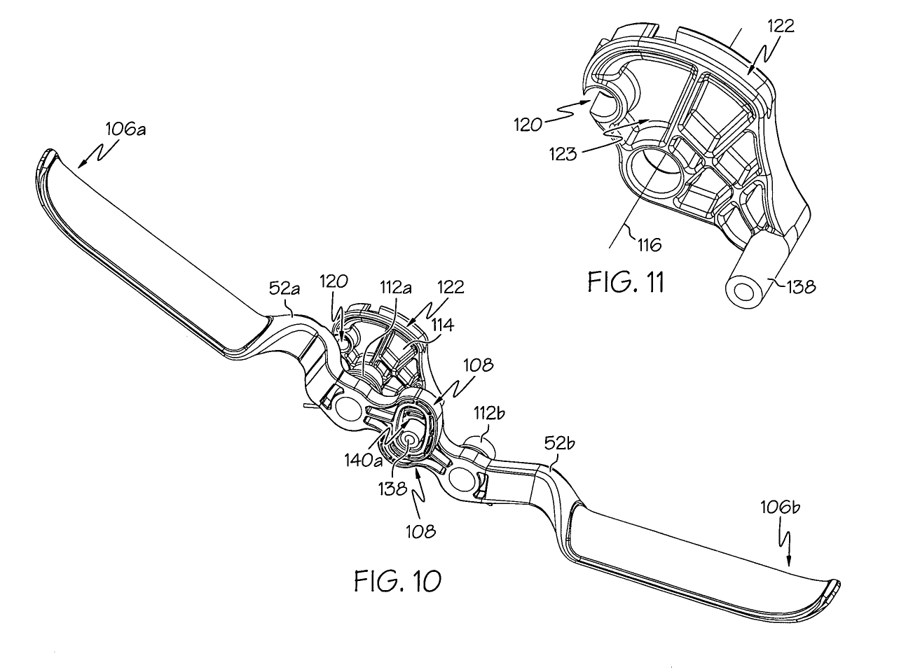

Each trigger 52a, 52b can generally include a finger grip portion 106a, 106b located towards one end, and an operation member 108a, 108b located towards the opposite end. With reference to FIG. 1, the direction of arrow C is oriented generally towards the grip portion 34 of the handle 28 such that an operator can selectively operate the triggers 52a, 52b with his/her fingers via the finger grip portion 106a, 106b, while the remainder of his/her hand rests upon the grip portion 34 of the handle 28. Additionally, each of the triggers 52a, 52b can be rotatably coupled to the housing 100 in various manners. For example, as shown, the triggers 52a, 52b can be directly rotatably coupled to the housing 100, such as directly onto a shaft or the like, or indirectly, via bearings 110a, 110b, bushings, or the like. In addition or alternatively, a one or more biasing members 112a, 112b can be coupled to the triggers 52a, 52b to bias the triggers 52a, 52b towards the disengaged position 104. For example, as shown in FIG. 10, a plurality of biasing members 112a, 112b, such as springs or the like, can each be coupled to one of the plurality of triggers 52a, 52b for biasing a respective trigger 52a, 52b towards the disengaged position 104. As a result, the triggers 52a, 52b can be biased to return to the disengaged position 104 to operate the transmission 44 in the halt condition when released by the fingers of the operator.

The trigger control system 38 can further include a cam 114 rotatably coupled to the housing 100 about a cam rotation axis 116. The cam 114 can be rotatably coupled to the housing 100 in various manners, such as directly rotatably coupled to the housing 100 on a shaft or the like, or indirectly, via bearings, bushings, or the like. For example, as shown in FIGS. 8-10, the cam 114 can be rotatably coupled to the housing 100 such that the rotational axis 116 of the cam 114 is coaxial with the rotational axis of at least one of the triggers, such as trigger 52a. The cam 114 and trigger 52a can share a common shaft and/or bearing 110a, or even other structure. Moreover, the cam 114 can be independently rotatable relative to the housing 100 and either of the triggers 52a, 52b. Still, the cam 114 can also be coupled to one of the triggers 52a so as to be directly rotatable therewith.

As shown in FIG. 9, the cam 114 can also be operatively coupled to one end of the cable 42. Thus, rotation of the cam 114 in a first direction about the cam rotation axis 116 can relatively decrease the tension of the cable 42, while rotation in a second direction can relatively increase the tension of the cable 42. Similarly, rotation of the cam 114 in the first direction can adjust the position of the cable 42 to be relatively closer to the transmission 44, and while rotation in the second direction can adjust the position of the cable 42 to be relatively farther from the transmission 44. The cam 114 can be coupled to the cable 42 in various manners. In one example, the cable 42 can include an enlarged end 118 that is captured by corresponding structure of the cam 114, such as an aperture 120. In other example, the cable 42 can be coupled to the cam 114 by various mechanical fasteners, welding, adhesives, etc. In addition or alternatively, the cam 114 can also include cable guide structure 122, such as a recessed channel or the like, that extends about a portion thereof, such as an outer peripheral edge. The cable guide structure 122 can facilitate guiding, winding, and/or other movement of the cable 42 relative to the cam 114 upon rotational movement of the cam 114 so as to inhibit, such as prevent, binding of the cable 42. In addition or alternatively, the cam 114 can include strengthening structure 123, such as ribs or the like.

It is to be understood that, where the cable 42 is a cable movable within a flexible conduit, the cam 114 can generally be coupled to the movable, flexible cable 124 contained within a fixed outer casing 126 thereof. For example, as shown in FIG. 9, the fixed outer casing 126 can be coupled to the housing 100 by way of a T-nut 128 or other structure, retained by corresponding structure of the housing 100, so as to retain the outer casing 126 generally against translational movement, while permitting translational movement of the internal movable, flexible cable 124 due to rotation of the cam 114. Similarly, the cable movable within a flexible conduit can include fixture structure 130 at the opposite end that can also be coupled to a portion of the mower 20, such as a securement portion 132 of the transmission 44 (see FIG. 2). Moreover, as discussed previously herein, the other end of the movable, flexible cable 124 can be directly or indirectly coupled to the transmission 44, such as through a resilient member 134 (e.g., a spring). The cable movable within a flexible conduit can also include other structure, such as the previously discussed auxiliary tension adjuster 98 and/or protective caps 136 or the like. It is also be understood that the variable speed control 40 can be located variously about the cable 42, such as about a portion of the cable indicated by the broken section in FIG. 9.

The cam 114 can further include an actuation member 138 that is coupled to the cam 114 a distance from the cam rotation axis 116. For example, as shown, the actuation member 138 can include a projection or the like that extends away from the cam 114 along a direction generally parallel to the cam rotation axis 116. Moreover, because the actuation member 138 is spaced a distance from the cam rotation axis 116, a force applied to the actuation member 138 can cause movement thereof to thereby cause the cam 114 to rotate about the cam rotation axis 116. The actuation member 138 can be coupled to the cam 114 in various manners, such as by mechanical fasteners, adhesives, welding, etc, and/or can even be formed with the cam 114.

Turning back briefly to FIG. 10, each trigger 52a, 52b can include an operation member 108a, 108b for engagement with the actuation member 138 for causing rotation of the cam 114. The operation member 108a, 108b can include various structure and/or geometries for applying a force to the actuation member 138. In one example, the operation member 108a, 108b can include a projecting member, and/or a cup-shaped member having a “U”-shaped geometry or the like. In another example, any or all of the triggers 52a, 52b can include an aperture 140a, 140b extending partially or completely therethrough for at least partially receiving the actuation member 138. Usage of an aperture 140a, 140b can be beneficial to contain the actuation member 138 so as to inhibit, such as prevent, mechanical misalignment, binding, etc. The aperture 140a, 140b can include an internal surface 142 that at least partially defines the operation member 108a, 108b. For example, as shown, each of the triggers 52a, 52b can include an aperture 140a, 140b that extends therethrough, and has an internal surface 142 that defines the operation member 108a, 108b. Moreover, the apertures 140a, 140b can be generally aligned, and the actuation member 138 can extend at least partially through each of the apertures 140a, 140b. The actuation member 138 can be located adjacent the internal surface 142 of each of the apertures 140a, 140b. Thus, movement of the triggers 52a, 52b can cause engagement of the internal surface 142 with the actuation member 138 to apply a force thereto to cause rotational movement of the cam 114, whereby a tension of the cable 42 can be adjusted.

In other words, as shown in FIG. 9, movement of at least one of the triggers 52a′ towards the engaged position 102 (i.e., along the direction of arrow C) can cause a respective operation member 108a, 108b of said trigger 52a′ to move along the direction of arrow D (i.e., illustrated upwardly) to engage the actuation member 138 of the cam 114. Thus, the operation member 108a, 108b can impart a force to the actuation member 138 (i.e., along the direction of arrow D) to rotate the cam 114 about the cam rotation axis 116 in the second direction (i.e., along the direction of arrow E). As a result, the rotation of the cam 114 in the second direction can relatively increase tension in the cable 42, due to the moveable, flexible cable 124 being pulled and extended by rotation of the cam 114, whereby the transmission 44 is operated in the advancement condition. Conversely, when the trigger 52a′ is released by the operator, the biasing members 112a, 112b can cause the trigger 52a′ to rotate back in the opposite direction, whereupon the force applied by the operation member 108a, 108b will be reduced and/or released upon the actuation member 138 to permit the cam 114 to rotate back towards the first direction. The tension in the cable 42 will relatively decrease, and the transmission 44 will be operated in the halt condition. It is to be similarly understood that rotation of the cam 114 in the first direction (i.e., the disengaged position 104 of the triggers 52a, 52b) can relatively adjust the position of the cable 42 towards the transmission 44 to operate in the halt condition, while rotation of the cam 114 in the second direction (i.e., the engaged position 102 of the triggers 52a′, 52b′) can relatively adjust the position of the cable 42 away from the transmission 44 to operate in the advancement condition.

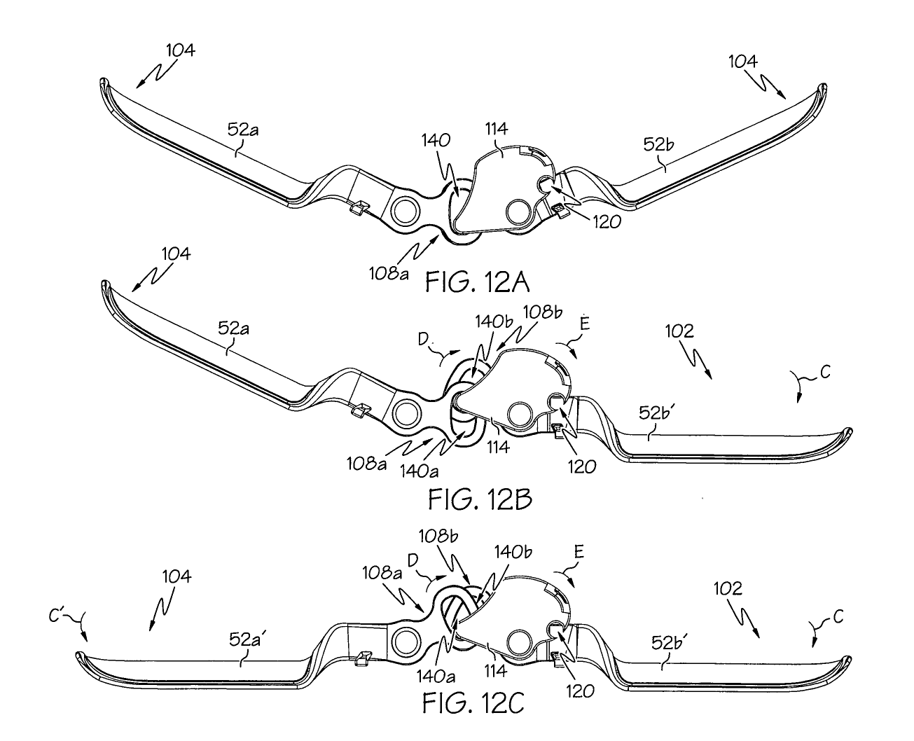

Turning now to FIGS. 12A-12C, and as discussed previously, the actuation member 138 can extend at least partially through each of the apertures 140a, 140b of all of the plurality of triggers 52a, 52b. Thus, it can be beneficial to have at least one of the apertures 140b of a selected one of the triggers 52b be of a size sufficient to permit the actuation member 138 to move freely within the aperture 140b while another of the triggers 52a is moved towards the engaged position 102. In other words, if the aperture 140b of the trigger 52b a size sufficient to permit the actuation member 138 to move freely therein, that trigger 52b can remain generally stationary while the other triggers 52a is moved towards the engaged position 102.

For example, as shown in FIG. 12A, the trigger control system 38 is illustrated with both of the triggers 52a, 52b in the disengaged position 104. The triggers 52a, 52b are located relative to each other such that the ends containing the operation members 108a, 108b are adjacent such that the apertures 140a, 140b thereof are generally aligned. The actuation member 138 of the cam 114 extends through each of the apertures 140a, 140b. The actuation member 138 is positioned generally towards a bottom portion of the apertures (i.e., adjacent the lower internal surface 142 of the apertures 140a, 140b) while both of the triggers 52a, 52b are in the disengaged position 104. Moreover, each of the apertures 140a, 140b extends a distance generally upwardly, relative to the internal surface 142. For example, as shown, each of the apertures 140a, 140b can include a generally curved geometry, such as an oval geometry. Still, the apertures 140a, 140b can have various geometries, such as circular, elliptical, rectangular, square, triangular, another polygonal shape, or even random.

Next, as shown in FIG. 12B, one of the triggers 52a′ is illustrated in the engaged position 102 rotated generally along the direction of arrow C. The operation member 108b of said trigger 52a′ similarly moves along the direction of arrow D (i.e., illustrated upwardly) to engage the actuation member 138 of the cam 114 to rotate the cam 114 about the cam rotation axis 116 in the second direction (i.e., along the direction of arrow E). As a result, the rotation of the cam 114 in the second direction can relatively increase tension in the cable 42. However, because the aperture 140b of the other trigger 52b has a size sufficient to permit the actuation member 138 to move freely therein, the other trigger 52b can remain in the disengaged position 104. In other words, as can be seen in FIG. 12B, the aperture 140b can have a size sufficient to permit the actuation member 138 to move freely therein while imparting zero, or substantially zero, force upon the other trigger 52b. In the shown example, the aperture 140b of the trigger 52b has a size sufficient to accommodate at least the vertical travel of the actuation member 138 when the trigger 52a′ is moved to the fully engaged position 102.

Furthermore, where the apertures 140a, 140b of both of the triggers 52a, 52b are sufficiently large, and/or may even have substantially the same geometry, such as shown in FIGS. 12A-12C, either of the triggers 52a, 52b can be independently moved between the engaged and disengaged positions 102, 104 without requiring movement of the other trigger 52a, 52b. Indeed, as shown in FIG. 12C, both of the triggers 52a′, 52b′ can be moved to the engaged position 102 (along the direction of arrows C, C′) to control operation of the transmission 44. Thus, an operator is provided the flexibility to control operation of the transmission 44 via either, or both, of the triggers 52a, 52b of the trigger control system 38.

In addition or alternatively, each of the triggers 52a, 52b can be configured to provide differing amounts of rotation of the cam 114, such as via differences in the geometries of the apertures 140a, 140b. For example, one of the triggers can cause rotation of the cam 114 within a first range, while another of the triggers can cause rotation of the cam 114 within a second range, where the second range is different (i.e., greater or smaller) than the first range. Still, any or all of the apertures 140a, 140b can also be designed to permit or require movement of one trigger in response to movement of another trigger.

In addition or alternatively, a selected one of the triggers, such as a trigger 52b having a rotational axis that is coaxial with the rotational axis 116 of the cam 114 (see FIGS. 12A-12C), can be adapted to be rotatably coupled to the cam 114 so as to rotate therewith. In other words, rotation of the trigger 52b between the engaged and disengaged positions 102, 104 can directly cause rotation of the cam 114 without engagement of the associated operation member 108a, 108b and actuation member 138. However, another of the triggers, such as trigger 52a, can still have an operation member 108a, 108b (i.e., an aperture 140a, 140b having an internal surface 142) for selective engagement with the actuation member 138 of the cam 114 (i.e., the aperture 140a, 140b having a size sufficient to permit the actuation member 138 to move freely therein). Thus, the cam 114 can be selectively operable by either of the triggers 52a, 52b. However, while the rotatably coupled trigger 52b can be operated independently, operation of the other trigger 52a would be dependent upon operation of the rotatably coupled trigger 52b. Still, such a configuration can also provide flexibility to the operator.

Although a lawn mower has been described herein as a walk-behind, self-propelled mower 20, the subject application is not limited to the lawn mower and can be applied to various kinds of working machines such as other grass cutting machines, cultivators, snow removal machines, and/or various other self-propelled machines.

The invention has been described with reference to the example embodiments described above. Modifications and alterations will occur to others upon a reading and understanding of this specification. Examples embodiments incorporating one or more aspects of the invention are intended to include all such modifications and alterations insofar as they come within the scope of the appended claims.

What is claimed is:

1. A self-propelled mowing machine 20, including:
a chassis 22;
a power unit 24 coupled to the chassis 22;
a handle 28 coupled to the chassis 22, including a grip portion 34;
a pair of driving wheels 26b rotatably coupled to the chassis 22;
a variable speed transmission 44 for propelling the mowing machine 20, interposed between the power unit 24 and the pair of driving wheels 26b;
an operational trigger 38 coupled to the handle 28 adjacent the grip portion 34 for operating the variable speed transmission 44 between a halt condition and an advancement condition;
a cable 242 coupled between the operational trigger 38 and the variable speed transmission 44, whereby a self-propelled speed of the mowing machine 20 is controlled via a relative tension in the cable 242; and
a variable speed control apparatus 240 for controlling the relative tension in the cable 242, including:
a body 254, wherein an intermediate portion 256 of the cable 242 extends through the body 254;
a control lever 268 pivotally coupled to the body 254 for pivotal movement between a first lever position 70 and a second lever position 72;
a rotatable driving member 76 operatively coupled to the control lever 268; and
a cable tensioner 84 coupled to the intermediate portion 256 of the cable 242 and operatively coupled to the driving member for movement between a first tensioner position to relatively decrease tension in the cable 242, and a second tensioner position to relatively increase tension in the cable 242,
wherein pivotal movement of the control lever 268 causes rotational movement of the driving member which in turn causes movement of the cable tensioner 84 relative to the control lever 268.

2. The self-propelled mowing machine 20 of claim 1, wherein the driving member is adapter to cause generally linear movement of the cable tensioner 84 relative to the control lever 268.

3. The self-propelled mowing machine 20 of claim 2, wherein the cable tensioner 84 is adapted for linear movement along an axis 293 oriented generally transverse to a longitudinal axis 293 of the cable 242.

4. The self-propelled mowing machine 20 of claim 1, wherein the cable tensioner 84 is adapted to provide infinite adjustability of the tension in the cable 242 within a range defined between the first tensioner position and the second tensioner position.

5. The self-propelled mowing machine 20 of claim 1, wherein the rotatable driving member 76 including a plurality of protrusions 295 extending a distance therefrom, the intermediate portion 256 of the cable 242 extending between the protrusions 295 in a serpentine fashion.

6. The variable speed control apparatus 240 of claim 1, wherein the rotatable driving member 76 includes a rotatable cam 114 pivotable about an axis 293 and including a generally circular portion 397 at one end 31 thereof, and an extended cam portion 395 at the other end 31 thereof, the extended cam portion 395 having a radius with respect to the axis 293 relatively greater than a radius of the generally circular portion 397 with respect to the axis 293.

7. The self-propelled mowing machine 20 of claim 1, wherein the cable tensioner 84 includes at least one of a generally “C”-shaped geometry and a generally “U”-shaped geometry for coupling to the intermediate portion 256 of the cable 242.

8. The self-propelled mowing machine 20 of claim 1, wherein the control lever 268 includes a sensory feedback element 94 for engagement with corresponding structure to provide sensory feedback to an operator upon pivotal movement of the control lever 268.

9. The self-propelled mowing machine 20 of claim 1, wherein the operational trigger 38 includes a plurality of triggers 52a, and wherein each of the plurality of triggers 52a can independently control operation of the variable speed transmission 44.

10. A self-propelled mowing machine 20, including:
a chassis 22;
a power unit 24 coupled to the chassis 22;
a handle 28 coupled to the chassis 22, including a grip portion 34;
a driving wheel rotatably coupled to the chassis 22;
a variable speed transmission 44 for propelling the mowing machine 20, interposed between the power unit 24 and the driving wheel;
an operational trigger 38 coupled to the handle 28 adjacent the grip portion 34 for operating the variable speed transmission 44 between a halt condition and an advancement condition;
a cable 242 coupled between the operational trigger 38 and the variable speed transmission 44, whereby a self-propelled speed of the mowing machine 20 is controlled via a relative position of the cable 242; and
a variable speed control apparatus 240 for controlling the relative position of the cable 242, including:
a body 254;
a control lever 268 rotatably coupled to the body 254 for rotational movement between a first position 70 and a second position 72; and
a cable adjuster 291 operatively coupled to the control lever 268 and adapted to rotate together with the control lever 268, the cable adjuster 291 including a cable coupler 86 adapted to engage the intermediate portion 256 of the cable 242 and to be moveable between a first adjuster position and a second adjuster position,
wherein rotational movement of the control lever 268 towards the first position 70 causes movement of the cable coupler 86 towards the first adjuster position to adjust the intermediate portion 256 of the cable 242 to be relatively closer to the transmission 44, and wherein rotational movement of the control lever 268 towards the second position 72 causes movement of the cable coupler 86 towards the second adjuster position to adjust the intermediate portion 256 of the cable 242 to be relatively farther from the transmission 44.

11. The self-propelled mowing machine 20 of claim 10, wherein the cable adjuster 291 is adapted for linear motion along an axis 293 oriented generally transverse to a longitudinal axis 293 of the cable 242.

12. The self-propelled mowing machine 20 of claim 10, wherein the cable adjuster 291 is adapted to provide infinite adjustability of the position of the cable 242 within a range defined between the first adjuster position and the second adjuster position.

13. The self-propelled mowing machine 20 of claim 10, wherein the cable adjuster 291 includes a rotatable member including a plurality of protrusions 295 extending a distance therefrom, the intermediate portion 256 of the cable 242 extending between the protrusions 295 in a serpentine fashion.

14. The self-propelled mowing machine 20 of claim 10, wherein the cable adjuster 291 includes a rotatable cam 114 pivotable about an axis 293 and including a generally circular portion 397 at one end 31 thereof, and an extended cam portion 395 at the other end 31 thereof, the extended cam portion 395 having a radius with respect to the axis 293 relatively greater than a radius of the generally circular portion 397 with respect to the axis 293.

15. The self-propelled mowing machine 20 of claim 10, wherein the cable coupler 86 includes at least one of a generally “C”-shaped geometry and a generally “U”-shaped geometry for coupling to the intermediate portion 256 of the cable 242.

16. The self-propelled mowing machine 20 of claim 10, wherein the operational trigger 38 includes a plurality of triggers 52a, and wherein each of the plurality of triggers 52a can independently control operation of the variable speed transmission 44.

17. A variable speed control apparatus 240 for controlling a self-propelled speed of a mowing machine 20 including an operational trigger 38 and a variable speed transmission 44, the variable speed control apparatus 240 including:
a body 254;
a cable 242 coupled between the operational trigger 38 and the variable speed transmission 44, wherein an intermediate portion 256 of the cable 242 extends through the body 254;
a control lever 268 rotatably coupled to the body 254 for rotational movement between a first position 70 and a second position 72; and
a cable adjuster 291 operatively coupled to the control lever 268 and adapted to rotate together with the control lever 268, the cable adjuster 291 including a cable coupler 86 adapted to engage the intermediate portion 256 of the cable 242 and to be moveable between a first adjuster position and a second adjuster position,
wherein rotational movement of the control lever 268 towards the first portion causes movement of the cable coupler 86 towards the first adjuster position to relatively decrease tension in the cable 242, and wherein rotational movement of the control lever 268 towards the second portion causes movement of the cable coupler 86 towards the second adjuster position to relatively increase tension in the cable 242.

18. The variable speed control apparatus 240 of claim 17, wherein the cable adjuster 291 is adapter to translate rotational motion of the control lever 268 into generally linear motion.

19. The variable speed control apparatus 240 of claim 17, wherein the cable adjuster 291 can include a rotatable member including a plurality of protrusions 295 extending a distance therefrom, the intermediate portion 256 of the cable 242 extending between the protrusions 295 in a serpentine fashion.

20. The variable speed control apparatus 240 of claim 17, wherein the cable adjuster 291 includes a rotatable cam 114 pivotable about an axis 293 and including a generally circular portion 397 at one end 31 thereof, and an extended cam portion 395 at the other end 31 thereof, the extended cam portion 395 having a radius with respect to the axis 293 relatively greater than a radius of the generally circular portion 397 with respect to the axis 293.
